(19) United States
(12) Patent Application Publication
(10) Pub. No.: US 2009/0116217 A1
(43) Pub. Date: May 7, 2009

(54) LED lighting apparatus having separate wavelength conversion unit

(75) Inventors: Kuo-Hsin Teng, Taipei (TW); Hon-Lun Chen, Taipei (TW); Cai-Nan Lee, Taipei (TW); Jyh-Way Wu, Taipei (TW); Ching-Yuan Huang, Taipei (TW)

Correspondence Address: REED SMITH LLP, Suite 1400, 3110 Fairview Park Drive, Falls Church, VA, 22042, US

(73) Assignee: PRODISC TECHNOLOGY INC.

(21) Appl. No.: 12/068,416

(22) Filed: Feb. 6, 2008

(30) Foreign Application Priority Data
Nov. 6, 2007 (TW) 096141785

(51) Int. Cl. F21V 9/16; G02B 6/00

(52) U.S. Cl. 362/84; 385/141

(57) ABSTRACT

The present invention provides an LED lighting apparatus having a separate wavelength conversion unit, which comprises the wavelength conversion unit and an LED. The wavelength conversion unit has an optical component and a wavelength conversion layer. The LED may be such positioned that the wavelength conversion layer is excited thereby. By forming the wavelength conversion unit at a surface of the optical component, the process of the LED can be simplified and the yield can be improved. Further, the present invention contributes to extending the application scope of the LED lighting apparatus by separating the wavelength conversion unit from the LED, so as to achieve optically desired light beams with evenness.

### BACKGROUND OF THE INVENTION

1. Technical Field

The present invention relates to LED (light-emitting diode) lighting apparatuses and, more particularly, to an LED lighting apparatus having a separate wavelength conversion unit.

2. Description of Related Art

Currently, a white LED may be realized by packaging red, green, and blue LED chips in an LED seat and implementing driving currents with different intensities to drive the red, green, and blue LED chips, respectively, so as to mix the emitted lights therefrom to generate a white light. However, since at least three LED chips are required to generate the white light and a complex circuit has to be devised for accurately controlling the driving currents, such white LED requires a relatively high manufacturing cost and therefore is not feasible for daily lighting.

To remedy the foregoing problem, a technology using colored LEDs together with a fluorescent material to produce a white LED has been developed and introduced to the industry. Therein, since a blue LED chip is superior in brightness as compared with LED chips of other colors, it is used together with a yellow fluorescent material that can be excited to emit a yellow light by the blue LED chip in order to produce a white LED that emits a white light. In such white LED, part of the blue light emitted by the blue LED chip excites the yellow fluorescent material to emit the yellow light, and the rest of the blue light gets mixed with the yellow light, so that the white LED emits a white light.

FIG. 1 structurally illustrates a conventional LED 10, which comprises a base 11, an LED chip 12, a fluorescent material 13 and an optical component 14. As shown in FIG. 1, the fluorescent material 13 of the conventional LED 10 is typically mixed well with an optical packaging adhesive first and then directly coated on the LED chip 12. Afterward, the optical component 14, such as a lens, is mounted upmostly to protect the fluorescent material 13 and to provide designed optical effects. The optical component 14 may define a beam angle where the LED 10 emits the light so as to enable various applications of the LED 10. However, since the fluorescent material 13 covering on the LED chip 12 has an uneven thickness, after the optical component 14 defines the beam angle of the LED 10, the LED 10 even more tends to present uneven light beams. Hence, the relevant manufactures have made efforts to develop LED products emitting light beams with enhanced evenness.

Furthermore, in order to ensure the desired yield of the LED 10, during the complex process of coating the LED chip 12 with the fluorescent material 13, it is not only sediment of the fluorescent material 13 accumulated on the LED chip 12 during packaging to be avoided, but also undesired air bubbles produced during applying the fluorescent material 13 to be prevented so as to eliminate adverse light-emitting effect of the LED 10 caused by such sediment and air bubbles. Hence, how to enhance the yield of LED products with reduced manufacturing costs and simplified process would be a subject for the industry to research.

### SUMMARY OF THE INVENTION

The present invention provides an LED lighting apparatus having a separate wavelength conversion unit, wherein by separating the wavelength conversion unit from an LED, the process of the LED is simplified and the problem of an uneven thickness of a fluorescent material covering LED chips is remedied so that the LED can emit even light beams.

To achieve the above objectives, the present invention provides an LED lighting apparatus having a separate wavelength conversion unit, which comprises: the wavelength conversion unit, having an optical component with a surface and a wavelength conversion layer formed on the surface; and at least one LED, such positioned that the wavelength conversion layer can be excited thereby, wherein each said LED comprises: a base, an LED chip deposited on the base, and a lens formed on the base while covering the LED chip.

To achieve the above objectives, the present invention provides a wavelength conversion unit, which comprises an optical component with a surface and a wavelength conversion layer formed on the surface.

The present invention achieves at least the following progressional effects:
1. The present invention remedies the problem of the prior arts where the fluorescent material directly covering the LED chips causes the fluorescent material to deposit on the LED chips during the process.
2. The present invention reduces the processing difficulty and simplifies the processing procedures so as to improve the yield of the lighting apparatus.
3. The present invention addresses the problem of the prior arts where the fluorescent material directly covering the LED chips causes uneven thickness of the fluorescent material that leads to uneven white light beams.
4. The present invention enables flexible applications of the lighting apparatus by providing possibility of various configurations between the wavelength conversion unit and the LED.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a sectional view of a conventional LED;

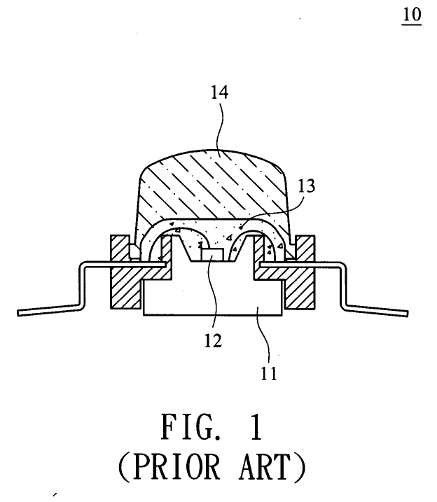

FIG. 2A is one embodiment of a schematic exploded view of an LED lighting apparatus having a separate wavelength conversion unit according to the present invention;

FIG. 2B is one embodiment of a sectional view of the LED lighting apparatus having the separate wavelength conversion unit according to the present invention;

FIG. 3 is another embodiment of a sectional view of the LED lighting apparatus having the separate wavelength conversion unit according to the present invention; and

FIG. 4 is an applied view of the LED lighting apparatus having the separate wavelength conversion unit according to the present invention.

### DETAILED DESCRIPTION OF THE PREFERRED EMBODIMENT

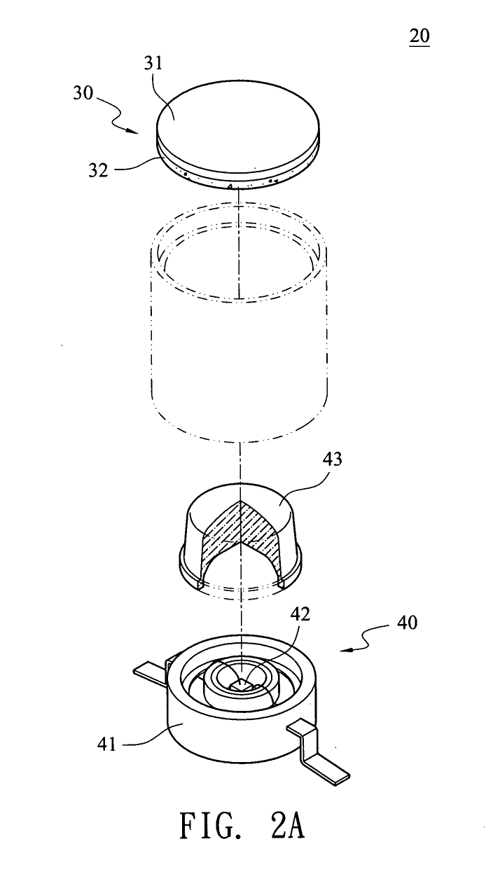

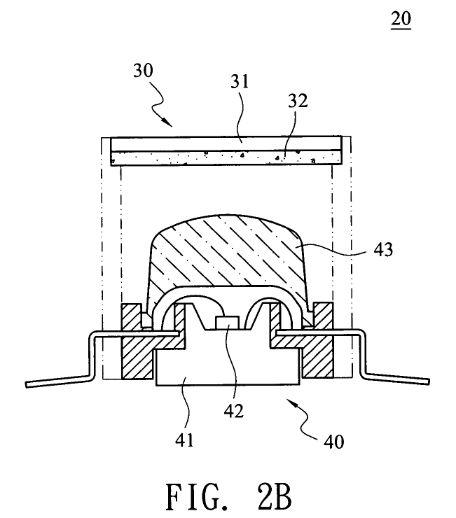

As shown in FIGS. 2A and 2B, the disclosed LED lighting apparatus 20 having the separate wavelength conversion unit according to the present embodiment comprises a wavelength conversion unit 30 and at least one LED 40. The wavelength conversion unit 30 and the LED 40 can be jointly assembled in a housing used as a supporting base.

The wavelength conversion unit 30 comprises an optical component 31 and a wavelength conversion layer 32. The optical component 31 has a surface and the wavelength conversion layer 32 is formed on the surface of the optical component 31. The optical component 31 may be a lens, a Fresnel lens or a diffuser. The wavelength conversion layer 32 is made of a yellow fluorescent material, or a hybrid material from yellow and red fluorescent materials.

The wavelength conversion layer 32 may have an average thickness ranging from 1 nm to 3 nm and may be formed by a physical vapor deposition (PVD) method, such as evaporation deposition, ion plating or sputtering deposition, in an operating environment preferably ranging from 100° C. to 500° C.

The LED 40 comprises a base 41, an LED chip 42 and a lens 43. Therein the base 41 functions as a carrier, and is equipped with a lead frame for electrically connected to a circuit board 50. The LED chip 42 is mounted on the base 41, and electrically connected to the lead frame by wire bounding. The lens is formed on the base 41 and covers the LED chip 42.

The LED chip 42 may be a blue LED lighting source. Since such blue LED lighting source presents superior brightness, when the blue LED lighting source is employed together with the yellow fluorescent material, part of the blue light emitted by the blue LED lighting source can excite the yellow fluorescent material to generate a yellow light and the rest of the blue light can then get mixed with the excited yellow light so that the LED light apparatus 20 can emit a white light.

A beam angle of the LED 40 is defined through the lens and may range from +60 degrees to −60 degrees. Meanwhile, the LED 40 is separated from the wavelength conversion layer for a predetermined distance, and is such positioned that the wavelength conversion layer 32 can be excited thereby. By such designed beam angle and position, the LED 40 can excite the wavelength conversion layer 32 in order to present the white light. Since the fluorescent material is not directly applied to the LED 40, the problems of the prior arts can be eliminated and the yield can be improved.

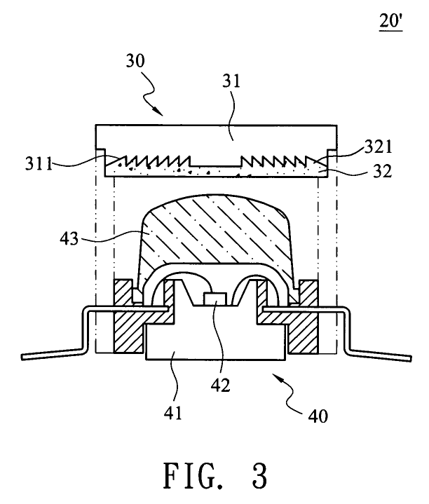

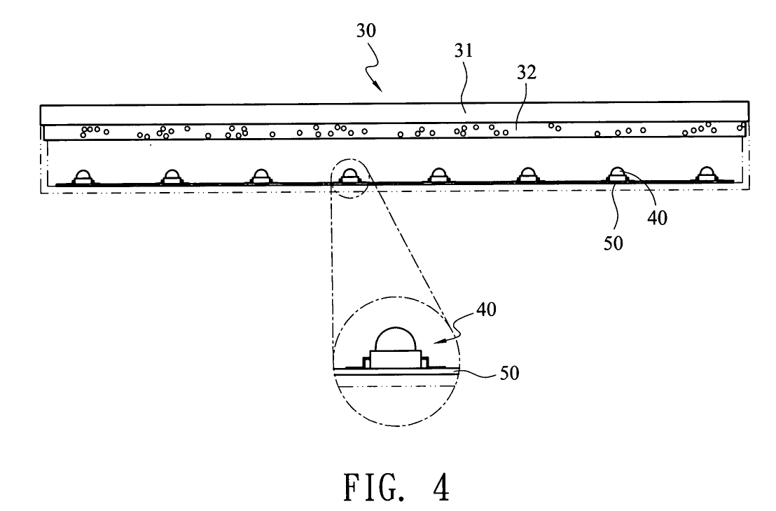

As shown in FIG. 3, the wavelength conversion layer 32 may further comprise a plurality of protrusions, and the optical component 31 may further comprise a plurality of recesses correspondingly. The protrusions of the wavelength conversion layer 32 may be formed by molding while the recesses of the optical component 31 may be made of plexiglass by injection molding or other molding methods. The protrusions of the wavelength conversion layer 32 are for being combined with the recesses of the optical component 31 to form the integral wavelength conversion unit 30. As shown in FIG. 4, the present embodiment further provides an LED lighting apparatus with a relatively large size. In the disclosed LED lighting apparatus, plural said LEDs 40 can be mounted on a single circuit board 50 to form an arrayed structure. The dimensions of wavelength conversion unit 30 may be such configured to match the dimensions of the LED 40 array formed on the circuit board 50 so that the LED lighting apparatus with the relatively large size can be achieved.

Although the particular embodiments of the invention have been described in detail for purposes of illustration, it will be understood by one of ordinary skill in the art that numerous variations will be possible to the disclosed embodiments without going outside the scope of the invention as disclosed in the claims.

1. An LED lighting apparatus having a separate wavelength conversion unit, comprising:
the wavelength conversion unit, including an optical component having a surface, and a wavelength conversion layer formed on the surface; and
at least one LED positioned such that the wavelength conversion layer can be excited thereby, and including a base, an LED chip mounted on the base, and a lens formed on the base and covering the LED chip.

2. The LED lighting apparatus of claim 1, wherein the optical component is a lens, a Fresnel lens or a diffuser.

3. The LED lighting apparatus of claim 1, wherein the wavelength conversion layer is made of a yellow fluorescent material.

4. The LED lighting apparatus of claim 1, wherein the wavelength conversion layer is made of a hybrid material from a yellow fluorescent material and a red fluorescent material.

5. The LED lighting apparatus of claim 1, wherein the wavelength conversion layer further comprises a plurality of protrusions, and the optical component comprises a plurality of recesses, in which the recesses and the protrusions are combined mutually as an integral unit.

6. The LED lighting apparatus of claim 1, wherein the LED chip is a blue LED lighting source.

7. The LED lighting apparatus of claim 1, wherein a beam angle of the LED is defined as ranging from +60 degrees to −60 degrees.

8. The LED lighting apparatus of claim 1, wherein the LED is separated from the wavelength conversion layer for a predetermined distance.

9. The LED lighting apparatus of claim 1, wherein the LED is further mounted on and electrically connected to a circuit board.

10. A wavelength conversion unit, comprising:
an optical component, having a surface; and
a wavelength conversion layer formed on the surface.

11. The wavelength conversion unit of claim 10, wherein the optical component is a lens, a Fresnel lens or a diffuser.

12. The wavelength conversion unit of claim 10, wherein the wavelength conversion layer is made of a yellow fluorescent material.

13. The wavelength conversion unit of claim 10, wherein the wavelength conversion layer is made of a hybrid material from a yellow fluorescent material and a red fluorescent material.

14. The wavelength conversion unit of claim 10, wherein the wavelength conversion layer further comprises a plurality of protrusions, and the optical component comprises a plurality of recesses, in which the recesses and the protrusions are combined mutually as an integral unit.
